(19) United States
(12) Patent Application Publication
(10) Pub. No.: US 2022/0179244 A1
(43) Pub. Date: Jun. 9, 2022

(54) TIME-VARYING METASURFACE STRUCTURE

(71) Applicant: Purdue Research Foundation, West Lafayette, IN (US)

(72) Inventors: Amr Mohammad E. Shaltout, West Lafayette, IN (US); Alexander V. Kildishev, West Lafayette, IN (US); Vladimir M. Shalaev, West Lafayette, IN (US)

(73) Assignee: Purdue Research Foundation, West Lafayette, IN (US)

(21) Appl. No.: 17/387,817

(22) Filed: Jul. 28, 2021

Related U.S. Application Data
(63) Continuation of application No. 15/209,737, filed on Jul. 13, 2016, now abandoned.
(60) Provisional application No. 62/191,705, filed on Jul. 13, 2015.

(51) Int. Cl. G02F 1/00; G02F 1/29; G02B 3/00; G02F 1/01; G02F 1/09; G02F 1/355; G02B 1/00

(52) U.S. Cl. CPC G02F 1/0063; G02F 1/29; G02B 3/0081; G02F 1/0136; G03H 2001/0224; G02F 1/355; G02B 1/002; G02F 2202/30; G02F 2203/10; G02F 1/093

(57) ABSTRACT

A time-varying optical metasurface, comprising a plurality of modulated nano-antennas configured to vary dynamically over time. The metasurface may be implemented as part of an optical isolator, wherein the time-varying metasurface provides uni-directional light flow. The metasurface allows the breakage of Lorentz reciprocity in time-reversal. The metasurface may operate in a transmission mode or a reflection mode.

### CROSS-REFERENCE TO RELATED APPLICATIONS

The present patent application is continuation of U.S. patent application Ser. No. 15/209,737 filed Jul. 13, 2016, which is related to and claims the priority benefit of U.S. Provisional Patent Application Ser. No. 62/191,705, filed Jul. 13, 2015, the contents of which is hereby incorporated by reference in their entireties into the present disclosure.

### STATEMENT REGARDING GOVERNMENT FUNDING

This invention was made with government support under W911NF-13-1-0226 awarded by the Army Research Office, FA9550-14-1-0389 awarded by the Air Force Office of Scientific Research; and DMR1120923 awarded by the National Science Foundation. The government has certain rights in the invention.

### TECHNICAL FIELD

The present disclosure relates to planar nanophotonics, and more specifically, optical devices having time-varying metasurfaces.

### BACKGROUND

The operation of conventional optical devices such as lenses or diffraction optical elements depends on the phase accumulation of light inside a bulk medium. By using the curvature of the structure, a new phase front is obtained which enables light focusing or other functionalities.

With the inception of optical metasurfaces, it has become possible to develop planar optical devices such as planar lenses. Their principle of operation depends on introducing an abrupt phase discontinuity instead of a gradual phase accumulation used in conventional bulk devices.

An optical metasurface typically consists of a planar array of subwavelength nano-antennas. Each antenna can locally tailor the optical wave-front phase and\or polarization; and hence, create a new wave-front that can be designed to perform a specific optical operation.

Optical metasurfaces have been used to implement numerous planar devices including light bending, planar lenses, planar holograms, half-wave plates, quarter-wave plates and polarization rotators.

The above prior art metasurfaces are based on phase discontinuity which is spatially varying along the metasurface. This space-variant phase caused relaxation of Snell's law—a cornerstone relation in optical design-, and thus several new functionalities were enabled with ultrathin planar devices unattainable with bulk curved structures or thick diffractive optical elements

However, the strength of metasurfaces with time-variant phase modality remained unexplored. Therefore, improvements are needed in the field.

### SUMMARY

The present disclosure provides a time-varying optical metasurface for use in planar optical devices. These devices include tunable versions of planar devices obtained by space-variant metasurfaces, such as planar lenses with tunable focal lens (axial scan focusing), beam steering, and holograms with dynamic images.

The impact of time-varying metasurfaces exceeds tunable devices, and new physical effects are obtained. Time-varying metasurfaces exhibit a more universal form of Snell's relation not limited by Lorentz reciprocity. This enables building magnetic-free optical isolators.

Non-reciprocity in time-reversal enables integrating with time-reversal mirrors to decouple back-reflected waves from sources.

Light interacting with time-varying metasurfaces also experiences wavelength shift similar to the Doppler shift. Metasurfaces with time-varying tangential gradient of material properties enable an alternative approach for the Doppler shift other than devices with mechanical movement of the reflecting or refracting interfaces. The metasurfaces with time-varying phase shift can also be integrated with mechanical systems to modify or compensate for the Doppler Effect. This wavelength modulation can also be utilized in optical communications to build frequency or phase modulators (FM or PM modulators)

Single photons go through inelastic interaction with time-varying metasurfaces leading to energy exchange. This can be used to control the energy eigenstate of single photons in quantum experiments.

Inelastic light interaction with time-varying metasurfaces is useful for integration with applications where energy exchange of light is used such as cavity optomechanical systems which are used for laser cooling.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 shows a schematic of a light beam incident on a space-time varying metasurface with angle of incidence θᵢ, reflected beam with angle of reflection θᵣ, and transmitted (refracted) beam with angle of transmission (refraction) θₜ according to on embodiment.

FIG. 2(a) shows a schematic of reflection angle from a time-gradient metasurface according to one embodiment.

FIG. 2(b) shows the reflection angle of the metasurface of FIG. 2(a) in time-reversal.

FIG. 3(a) shows a schematic of an optical isolator with uni-directional light flow using a time-varying metasurface and two high quality resonators during forward propagation of a light beam according to one embodiment.

FIG. 3(b) shows a schematic of the optical isolator of FIG. 3(a) during reverse propagation of the light beam.

FIG. 3(c) shows an optical isolator with same input/output frequency using two time-varying metasurfaces and a high quality resonator during forward propagation of a light beam according to one embodiment.

FIG. 3(d) shows the optical isolator of FIG. 3(c) during reverse propagation of the light beam.

### DETAILED DESCRIPTION

The time varying metasurface of the present disclosure comprises an array of tunable nano-antennas. These nano-antennas can be plasmonic nano-antennas made of metals including but not limited to gold, silver, aluminum, titanium nitride, zirconium nitride. The nano-antenna may also be dielectric nano-antennas comprising high-index dielectric including but not limited to silicon, germanium, and gallium arsenide.

Dynamic tunability of the antenna array may be achieved using varactor-based phase-shift elements for operation in radio-frequency or microwaves. For visible and infrared implementation, modulation can be obtained using electro-optic or acousto-optic modulation. Also, free-carrier (free electrons or free holes) modulation may be implemented using a control voltage signal operatively connected to the nano-antennas. Changing free carrier concentrations modifies the optical properties of the nano-antennas. These materials include transparent conducting oxides (TCOs) such as Indium Titanium Oxide (ITO), Aluminum-doped ZnO (AZO), Gallium-doped ZnO, or any other material that enables free carrier modulation. Free carriers can be either modulated electrically through applying variable voltage bias or optically through applying ultrafast optical pump pulses.

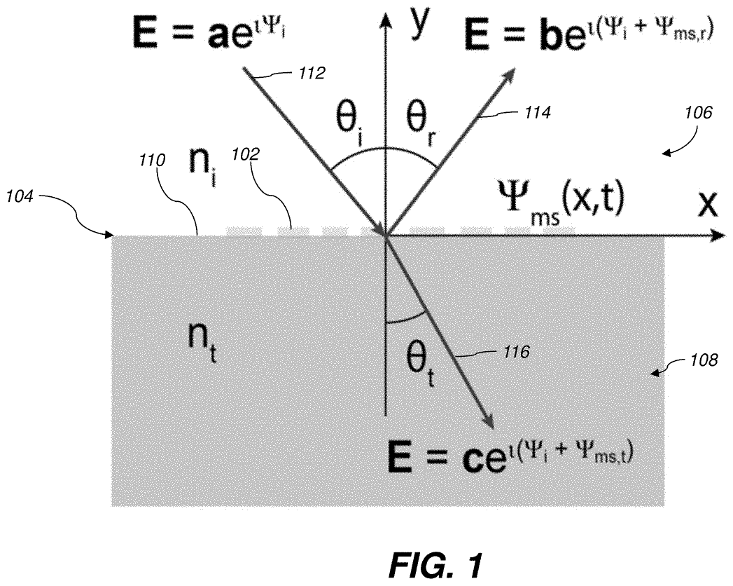

FIG. 1 shows the general case of having an array of antennas 102 at the interface 104 between two media 106 (incident media) and 108 (transmissive media) which is varying with both space and time according to one embodiment. A wave 112 with a phase of ψᵢ is incident on a metasurface 110, which induces a space-time varying phase-shift of ψ_{ms,r} for a reflected wave 114 and ψ_{ms,t} for refracted (transmitted) wave 116. This means that the phases of the reflected and transmitted waves are given by:

ψₛ=ψᵢ+ψ_{ms,s}, s={r,t}. (1)

By applying the time derivative to obtain the frequency w=−¶y/¶t and wave-vector
k=∇ψ, we obtain:

ωₛ=ωᵢ−∂ψ_{ms,s}/∂t, s={r,t}; (2)

k_{s,x}=k_{i,x}+¶y_{ms,s}/¶x, s={r,t}, (3)

where ωᵢ, ωᵣ, ωₜ, k_{i,z}, k_{r,x} and k_{t,x} are the frequencies and the x-components of the wave-numbers of incident, reflected and transmitted waves, respectively. Equation (3) can be rewritten in terms of the wavenumbers' amplitudes kᵢ, kᵣ, and kₜ as follows:

$$\begin{matrix}{k}_{r} sin {θ}_{r} = {k}_{i} sin {θ}_{i} + \frac{\partial {ψ}_{m s , r}}{\partial x} & ( 4 ) \\ {k}_{l} sin {θ}_{l} = {k}_{i} sin {θ}_{i} + \frac{\partial {ψ}_{m s , t}}{\partial x} , & ( 5 ) \\ where {k}_{i} = {n}_{i} {ω}_{i} / c and & \\ {k}_{s} = \frac{{n}_{s} {ω}_{s}}{c} = \frac{{n}_{s}}{c} ( {ω}_{i} - \frac{\partial {ψ}_{m s , s}}{\partial t} ) , s = \{ r , t \} , & ( 6 )\end{matrix}$$

with nᵢ (=nᵣ) and nₜ being the refractive indices of the incident media 106 and transmissive media 108, respectively.

The equations indicate that the space-gradient phase-shift introduces an abrupt change to the momentum of the photons with a value of Δp_{z}=hΔk_{z}=h∂ψₘₛ/∂x, and that a time-gradient phase-shift causes the energy of photons to change by the amount ΔE=ℏΔω=−ℏ∂ψₘₛ/∂t.

This amount of energy change may be used to control energy eigenstates of single photons in quantum experiments.

In one embodiment, the energy change may be used with other applications that utilize inelastic interaction with light, such as cavity optomechanics which is used in laser cooling. Time varying metasurface 110 may be integrated with these systems to provide additional control over energy exchange.

Equation (2) indicates that light exhibits frequency (or wavelength) shift which is similar to Doppler Effect experienced by light reflected from a moving surface. Time-varying metasurface 110 may be added to moving surfaces to modify or compensate for the Doppler shift.

Equations (4-6) represent the universal Snell relation of reflected and refracted angles from the space-time gradient metasurface. Equation (6) represents the effect induced by the time-varying metasurface 110 because it is responsible for the change in the values of kᵣ and kₜ, an effect not present without time variation.

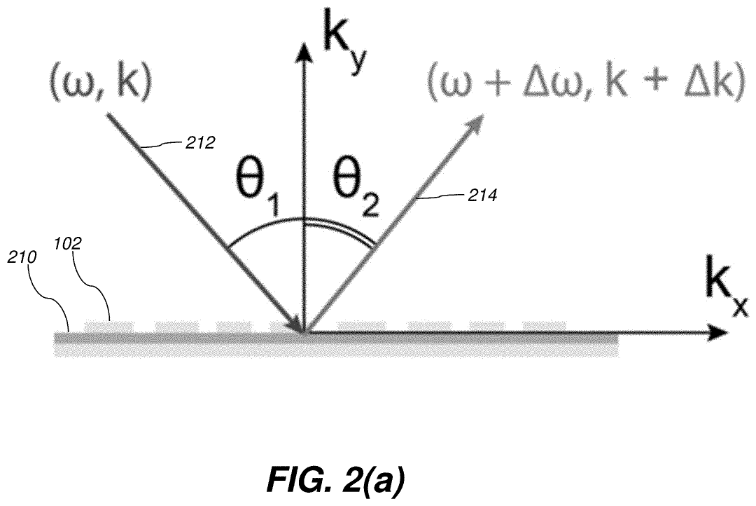

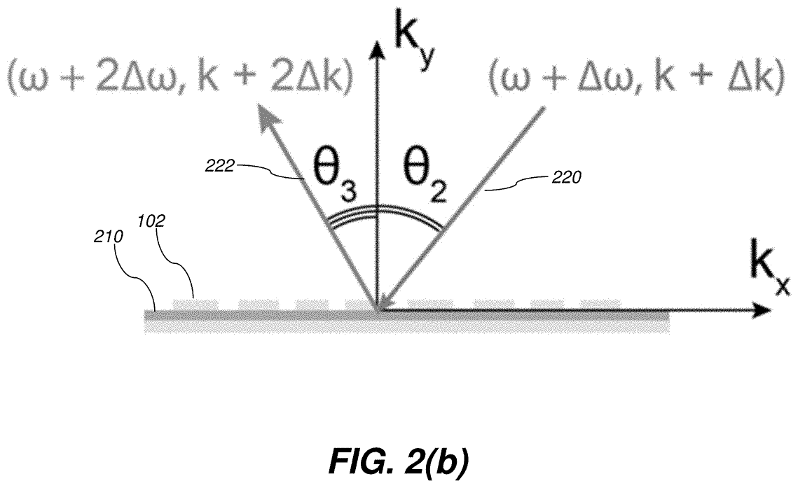

The above description applies to reflection from time-gradient metasurfaces in free space. A similar analysis may be extended to transmittance and for arbitrary media. FIG. 2(a) demonstrates a light beam 212 reflected from a time-gradient metasurface 210. For simplicity, we assume that there is no space-varying phase-shift (∂ψₘₛ/∂x=0), and that there is a linear variation of ψₘₛ with respect to time with a derivative value of Δω=−∂ψₘₛ/∂t. This can be obtained by introducing a periodic phase shift that changes linearly from π to −π during a period T=2π/Δω. Let the angles of incidence and reflection to this metasurface 210 be θ₁ and θ₂ as shown in FIG. 2(a). If frequency and wavenumber of incident waves are ω and k=ω/c, respectively, then equations (2) and (6) indicate that the frequency and the wavenumber of the reflected beam 214 are ω+Δω and k+Δk=(ω+Δω)/c. It follows from equation (4) that:

k sin θ₁=(k+Δk)sin θ₂. (7)

Using similar analysis for the time-reversal case shown in FIG. 2(b), we get:

(k+Δk)sin θ₂=(k+2Δk)sin θ₃. (8)

From equations (7) and (8) it follows that:

$$sin {θ}_{3} = \frac{sin {θ}_{1}}{1 + \frac{2 Δ k}{k}} = \frac{sin {θ}_{1}}{1 + \frac{2 Δ ω}{ω}} . \qquad ( 9 )$$

This concludes that back-reflected beam is not propagating along the direction of the incident beam 212.

In one embodiment, the time-varying metasurface 210 in FIG. 2 can be used as an optical isolator from port 1 along angle θ₁ and port 2 along angle θ₂ where S₂₁>0 and S₁₂≈0 because time-reversal cause back-reflected beam to deviate from θ₁ to q₃.

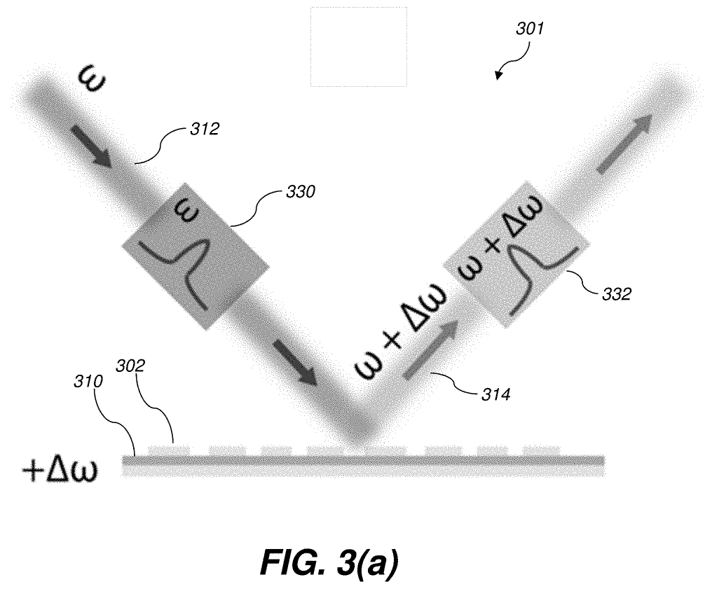

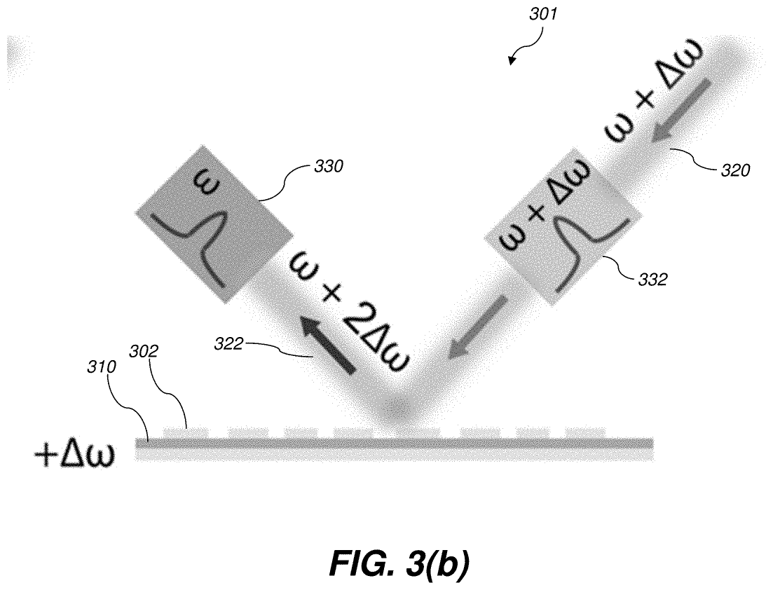

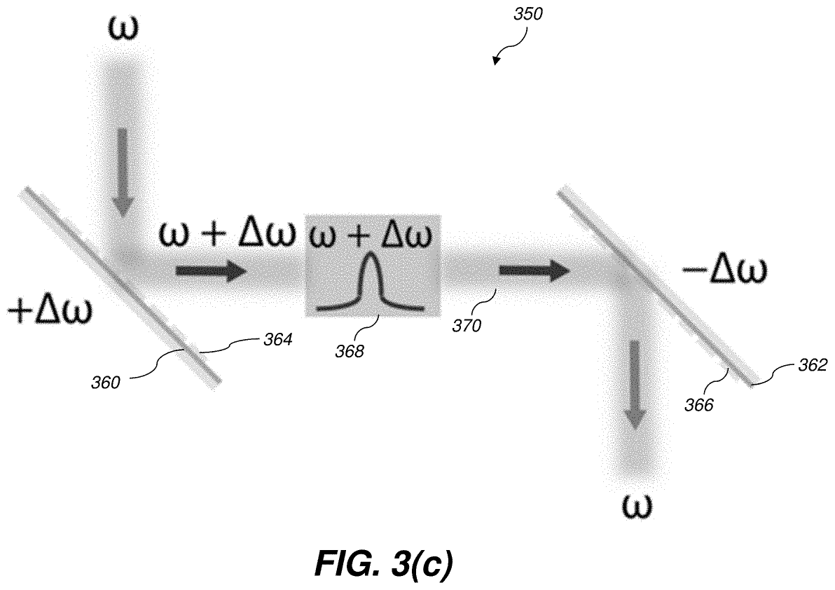

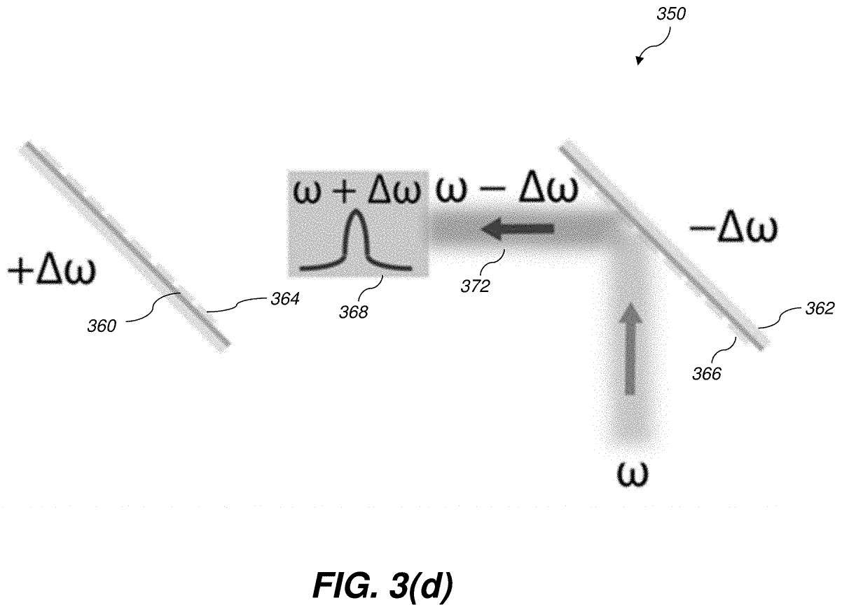

According to a further embodiment, optical isolators may be built based on non-reciprocity attributed to the difference in frequency values between the incident and back-scattered beams which can be decoupled using high quality optical filtering. In this case even a small change in the frequency would provide an observable effect. FIGS. 3(a) and 3(b) illustrates the schematics of an optical isolator 301 according to one embodiment which includes a metasurface 310 (similar to metasurfaces 110 and 210, and having nano-antennas 302) with a frequency shift of Δω=−∂ψₘₛ/∂t The isolator 301 also includes two optical resonators 330 and 332 with center frequencies of ω and ω+Δω. FIG. 3(a) shows the allowed forward propagation for an incident beam 312 of frequency ω and the reflected beam 314 of frequency ω+Δω, where both beams 312 and 314 pass through the optical resonators. FIG. 3(b) presents the backward propagation of the time-reversed ω+Δω beam 320, which is reflected at a shifted frequency of ω+2Δω and hence, the reversed beam 322 is blocked by the resonator 330.

FIGS. 3(c,d) show an isolator 350 with the same input and output frequencies according to one embodiment. The isolator 350 is composed of two metasurfaces 310 and 311 (which are similar to metasurfaces 110 and 210, and having nano-antennas 360 and 366 as shown) which induce frequency shifts with the same magnitude but opposite in direction as shown; and hence, they restore the same frequency in the output. The isolator 350 includes a resonator 368 tuned at ω+Δω in the path of light beam 370 between the two metasurfaces 360 and 366. The resonator 350 allows forward propagation of light as in FIG. 3(c), but blocks its backward propagation (e.g., of beam 372) as shown in FIG. 3(d).

It shall be understood that the metasurfaces described herein may be controlled using a voltage or other control signal from a controller operatively connected to the metasurface or nano-antennas. The controller may comprise, for example, a microcontroller having a computer processor and a memory configured to store information. The processor can implement processes of various aspects described herein. The processor can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise. The processor can include Harvard-architecture components, modified-Harvard-architecture components, or Von-Neumann-architecture components as non-limiting examples. The memory can be, e.g., within a chassis or as parts of a distributed system. The phrase “processor-accessible memory” is intended to include any data storage device to or from which processor 186 can transfer data (using appropriate components of peripheral system 120), whether volatile or nonvolatile; removable or fixed; electronic, magnetic, optical, chemical, mechanical, or otherwise. Exemplary processor-accessible memories include but are not limited to: registers, floppy disks, hard disks, tapes, bar codes, Compact Discs, DVDs, read-only memories (ROM), erasable programmable read-only memories (EPROM, EEPROM, or Flash), and random-access memories (RAMs). One of the processor-accessible memories in the microcontroller can be a tangible non-transitory computer-readable storage medium, i.e., a non-transitory device or article of manufacture that participates in storing instructions that can be provided to the processor for execution.

In certain embodiments, the metasurface may be provided as part of a magnetic-free optical isolator which will facilitate on-chip integration of the optical isolator. Furthermore, frequency shifting of light similar to the Doppler effect (Doppler effect is the frequency shift of light reflected from moving objects used in radar detection of speed) may be achieved using the metasurface disclosed herein by connect a controller to vary the metasurface properties over time. Time-varying metasurfaces on a moving object can modify the value of Doppler shift, or can even compensate for the Doppler shift which can be used to build a velocity cloak device. The metasurface may also be used to provide time-reversal of light which can be used to restore subwavelength features of diffracted light using in subwavelength imaging, used in biosensing and other vital applications. The metasurface may also be used in applications in quantum optics since single photons go through inelastic interaction with time-varying metasurfaces leading to energy exchange. This can be used to control the energy eigenstate of single photons in quantum experiments.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects These aspects can all generally be referred to herein as a “service,” “circuit,” “circuitry,” “module,” or “system.”

Furthermore, various aspects herein may be embodied as computer program products including computer readable program code stored on a tangible non-transitory computer readable medium. Such a medium can be manufactured as is conventional for such articles, e.g., by pressing a CD-ROM. The program code includes computer program instructions that can be loaded into the processor (and possibly also other processors), to cause functions, acts, or operational steps of various aspects herein to be performed by the processor. Computer program code for carrying out operations for various aspects described herein may be written in any combination of one or more programming language(s).

The invention is inclusive of combinations of the aspects described herein. References to “a particular aspect” or “embodiment” and the like refer to features that are present in at least one aspect of the invention. Separate references to “an aspect” (or “embodiment”) or “particular aspects” or the like do not necessarily refer to the same aspect or aspects; however, such aspects are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted.

The invention has been described in detail with particular reference to certain preferred aspects thereof, but it will be understood that variations, combinations, and modifications can be effected by a person of ordinary skill in the art within the spirit and scope of the invention.

1. A time-varying planar optical metasurface, comprising:
a plurality of nano-antennas disposed over a dielectric; and
a material that enables free carrier modulation, wherein the material includes aluminum-doped ZnO, or Gallium-doped ZnO, wherein the plurality of nano-antennas is configured to couple with an optical pump element through the material that enables free carrier modulation.

2. The metasurface of claim 1, wherein the metasurface is configured to operate as a meta-lens with tunable focus.

3. The metasurface of claim 1, wherein the metasurface is configured to operate as a beam-steering device.

4. The metasurface of claim 1, wherein the metasurface is configured to operate as a dynamic waveform shaping device.

5. The metasurface of claim 1, wherein the metasurface is configured to operate to produce holograms with dynamic images.

6. The metasurface of claim 1, wherein the metasurface is configured to operate as a tunable polarization plate device.

7. The metasurface of claim 1, wherein the metasurface is configured to operate as a tunable polarization rotator device.

8. The metasurface of claim 1, wherein the metasurface is configured to break Lorentz reciprocity in time-reversal.

9. The metasurface of claim 1, wherein the metasurface is configured to operate in a reflection mode.

10. The metasurface of claim 1, wherein the metasurface is configured to operate in a transmission mode.

11. The metasurface of claim 1, wherein the nano-antennas comprise plasmonic or gap-plasmonic antennas made of a metal.

12. The metasurface of claim 11, wherein each nano-antenna of the plurality of nano-antennas includes titanium nitride or zirconium nitride.

13. (canceled)

14. The metasurface of claim 1, wherein the dielectric is silicon, germanium, or gallium arsenide.

15.-20. (canceled)

21. The metasurface of claim 1, wherein the material that enables free carrier modulation includes indium tin oxide, aluminum-doped ZnO, or gallium-doped ZnO.

22. The metasurface of claim 1, further comprising an optical resonator configured to pass a beam therethrough toward the plurality of nano-antennas

23. The metasurface of claim 1, wherein the material that enables free carrier modulation includes transparent conducting oxides.

24. An optical device, comprising:
(a) a plurality of nano-antennas disposed over a dielectric, wherein each nano-antenna of the plurality of nano-antennas includes titanium nitride or zirconium nitride; and
(b) a modulating device operatively coupled with at least one nano-antenna of the plurality of nano-antennas through a material that enables free carrier modulation;
wherein the modulating device includes a voltage bias element or an optical pump element; and
wherein the material that enables free carrier modulation includes indium tin oxide, aluminum-doped ZnO, or gallium-doped ZnO.

25. The optical device of claim 24, wherein the optical device is configured to operate in a reflective mode.

26. The optical device of claim 24, wherein the optical device is configured to operate in a transmission mode.

27. The optical device of claim 24, wherein the optical device is configured to break Lorentz reciprocity in time-reversal.

28. An optical system, comprising:
(a) a plurality of nano-antennas disposed over a dielectric;
(b) an optical resonator configured to pass a beam therethrough toward the plurality of nano-antennas; and
(b) a modulating device operatively coupled with at least one nano-antenna of the plurality of nano-antennas through a material that enables free carrier modulation, wherein in the modulating device includes an optical pump element, wherein the material that enables free carrier modulation includes indium tin oxide, aluminum-doped ZnO, or gallium-doped ZnO.
